(19) United States
(12) Patent Application Publication
(10) Pub. No.: US 2013/0054401 A1
(43) Pub. Date: Feb. 28, 2013

(54) METHOD OF CUSTOMIZATION AND COMMERCE USING GAMING IMPLEMENTED BY SOFTWARE

(71) Applicant: Michael James Kelley, Lancaster, NY (US)

(72) Inventor: Michael James Kelley, Lancaster, NY (US)

(21) Appl. No.: 13/594,817

(22) Filed: Aug. 26, 2012

Related U.S. Application Data
(60) Provisional application No. 61/575,827, filed on Aug. 28, 2011.

(51) Int. Cl. G06Q 30/06

(52) U.S. Cl. 705/26.1

(57) ABSTRACT

A computerized method of enabling the purchasing of a physical good, comprising the steps of: enabling the playing of a game on a computer by a user, the game comprising a representation of the physical good; receiving one or more inputs from the user to develop the representation of the physical good; and, receiving an instruction from the user where the instruction indicates a desire to purchase the physical good and the physical good is associated with the representation.

### CROSS-REFERENCE TO RELATED APPLICATIONS

This document claims the benefits of provisional patent application Ser. No. 61/575,827 filed Aug. 28, 2011 by the present inventor.

### FEDERALLY SPONSORED RESEARCH

(not applicable)

### SEQUENCE LISTING OR PROGRAM

(not applicable)

### BACKGROUND

1. Field

The present disclosure relates to systems and methods of doing business and, more specifically, the present disclosure relates to videogames played on electronic devices to enable purchase of a physical good.

2. Related Art

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

In recent years there has been a trend towards developing videogames with the purpose of manipulating users and promoting a particular behavior (typically product consumption). This strategy capitalizes on humans' psychological predisposition to engage in game play and to invest emotionally in the game and its associated elements. A videogame designed around brand promotion (and by extension the consumption of its products) may be referred to as an “advergame.” Advergames have become an explosive, wildly successful segment of the overall videogame market. They have proven to generate remarkable revenue for both the game publisher and the game's sponsor. The strategy of branding games and game elements is limited, however, in that it only serves to advertise. Furthermore, the advertisements are limited to existing products designed by the game's sponsoring entity.

The advergame strategy only allows the game creator to capitalize on adrevenue and game sales. Videogame creators and publishers are struggling to find novel new ways to monetize their products as business models continue to evolve. Explosive competition has forced many creators and publishers to price their products at less than a dollar. Others are forced to give their products away for free and attempt to make money selling electron-bound game elements, such as additional in-game characters. Giving your product away and hoping that someone somewhere eventually pays for something is not typically the best business strategy.

The strategy of selling additional in-game content and the strategy of selling “DLC (downloadable content)” is not without further limitations. While videogames currently allow users to customize and purchase game elements, what is purchased remains stored in the game as electronic data. U.S. Pat. No. 20100203970 to Hope (2009) attempts some novelty however, by enabling a videogame narrative to be retold as a printed comic book or an e-book. It should be obvious that this constitutes re-transmittal rather than transformation. Only the medium is different, not the product that is the videogame narrative. The fact that the patent states the product may be displayed electronically or on paper obviates that the method of narrative transmission is fundamentally immaterial. Further, the comic book version of the videogame narrative is not imbued with significant gains in functionality over the e-book version again indicating irrelevance of form. Finally, what is being re-transmitted is the videogame narrative, which can hardly be said to be corporeal.

Figureprints.com offers a third-party service allowing a customer to purchase a material re-creation of their customized World of Warcraft game characters, Xobx Live avatars, and Minecraft scenes. Unlike the present disclosure, the process by which they recreate a game character is neither game-incorporated nor fully-automated. They are therefor unable to capitalize on the many substantial benefits made possible by the present disclosure.

As a third-party offering, Figureprints.com is unable to ensure that the World of Warcraft user base is aware of its service. Furthermore, the fact that the product is not game-incorporated means that the third-party offering is unable to direct the quantifiably beneficial psychological predispositions elicited through game play. Moreover, in order to make a purchase, the World of Warcraft player must disengage play and establish an account at Figureprints.com, thereby dispelling the sense of immersion that is so integral to the game experience and adding additional barriers to the purchase opportunity. Ultimately it does not and is unable to utilize gaming implemented by software.

In addition to adding barriers to the purchase opportunity, the fact that the process is not fully-automated adds additional barriers to the manufacturing process. It has been described by Ed Fries, FigurePrints founder, as “a very manual process.” That process is limited to materials printing, whereas in particular embodiments the current disclosure is able to capitalize on other manufacturing methods, pre-existing infrastructures and the quantifiable benefits of automated manufacturing.

Harvard, with partial funding from Pixar, has recently developed a process that analyzes a character's animation and prints out a jointed action figure. The process is not entirely clear but appears to be another third-party solution. It is not clear when research was begun. The process results in jointed figures that do not necessarily resemble the character they were modeled from. Harvard has filed a patent entitled “Method to fabricate articulated characters from skinned meshes.”

### Advantages

The present disclosure relates a method by which an incorporeal game element undergoes a significant material transformation and becomes a physical good available for purchase through the game itself. This offers whole new markets to an industry that currently relies on selling only immaterial content such as DLC and entertainment. As a result of the transformation the physical good gains distinct and significant functionality over its previously immaterial expression. As a physical realization of the game element, this new object can be interacted with. Through significant material transformation it becomes an object that can be perceived through all five senses. The method from which the custom-specified physical good issues is not limited to the re-mixing and rerunning of entertainment. The act of significant material transformation allows a whole host of industries to sell physical goods through engaging, immersive experiences.

Embodiments of the present disclosure improve upon the advergame strategy as well. Advergames are limited to advertising existing goods. Embodiments of the present disclosure accomplishes this by enabling users to describe, customize, select, and cause a product to evolve through game play. This is achieved by first enabling the playing of a game on a computer. The game comprises a game element that is a representation of a physical good. The game receives input from the user that results in the development of the game element. This is achieved through customization of the game element. Enabling development of the game element by way of customization offers purveyors of games and goods a significant market advantage as humans are known to invest emotionally in their own creations and customizations much more so than those of someone else. The act of customization is a way to individuate a thing for the very purpose of making it personally significant. There is a proven, direct correlation between an increase in game element customization options and increases in user retention. Embodiments of the present disclosure capitalize on this predilection for personalization by allowing the user to essentially design their own product through game element customization. Consequently, it also allows for crowd-sourcing product development through “gameification.”

Embodiments of the present disclosure enable a user to communicate the desire to purchase the custom-specified physical good whose representation is the customizable game element. This is achieved by enabling a user to communicate a custom-specifications file along with the desire to purchase the custom-specified physical good. The custom specifications file comprises detailed descriptions of the game element derived from user customization. It serves as specifications from which a custom-specified physical good can be elicited and made available for purchase. This data is communicated to an entity that is responsible for fulfilling the purchase order of the custom-specified physical good. Enabling customizable game elements to be purchased as physical constructs offers both the purveyors of videogames and goods a revolutionary new business model with which to monetize their wares.

In conclusion, insofar as I am aware, no other game-integrated method enables a custom-specified physical good to be elicited from a custom-specifications file comprising detailed descriptions of a game element derived from user customization. Embodiments of the present disclosure will have far-reaching ramifications across a host of industries and forever and irrevocably change the way videogames are monetized.

### SUMMARY

The present disclosure comprises a computerized method of enabling the purchasing of a physical good, comprising the steps of: enabling the playing of a game on a computer by a user, the game comprising a representation of the physical good; receiving one or more inputs from the user to develop the representation of the physical good; and receiving an instruction from the user where the instruction indicates a desire to purchase the physical good and the physical good is associated with the representation.

A primary object of embodiments of the present disclosure is to enable the purchase of a custom-specified physical good deriving its specifications from the customization of a game element.

A secondary object of embodiments of the present disclosure is to capitalize on humans' psychological predisposition to engage in game play and invest emotionally in the videogame and its associated customizable game element good.

A tertiary object of embodiments of the present disclosure is to efficiently enable the crowd-sourcing of product development.

These and other objects, features and advantages of embodiments of the present disclosure will become readily apparent to those having ordinary skill in the art upon a reading of the specification and claims in view of the appended drawings.

### BRIEF DESCRIPTION OF THE DRAWINGS

FIG. 1 illustrates the components of an embodiment in relation to one another.

FIG. 2 demonstrates typical but not exhaustive implementations of the game component giving a general over-view of their objectives, cause-and-effect relationships, hierarchies, and chronologies.

FIG. 3 is a flowchart enabling the development of an embodiment of the present disclosure.

FIGS. 4A-4B, are screen-shots of an interface of a game “BrickTown” implemented by software that demonstrates an embodiment and use thereof.

FIG. 4C is an example of a custom-specified physical good corresponding to a customizable game element in “BrickTown.”

FIG. 5 is a flowchart enabling the development of an embodiment of the present disclosure.

FIG. 6A is a screen-shot of an interface of a game “Super Super RPG” implemented by software that demonstrates an embodiment and use thereof.

FIG. 6B is an example of a custom-specified physical good corresponding to a customizable game element in “Super Super RPG.”

FIG. 7 illustrates the relationship between user input, a custom-specifications file, and a custom-specified physical good in an embodiment implementing the game component as “BrickTown.”

FIG. 8 depicts a system that may be used when playing a videogame and eliciting a custom-specified physical good in accordance with an embodiment of the present disclosure.

### DETAILED DESCRIPTION OF SPECIFIC EMBODIMENTS

Embodiments of the present disclosure are intended to enable a custom-specified physical good to be elicited from a custom-specifications file comprised of specifications set forth by a user through the customization of a game element. Although many videogames allow for game element customization, and many videogames allow for the purchase of game elements, what is purchased is incorporeal and bound by the parameters of the videogame. Embodiments of the present disclosure uniquely enable the purchase of a custom-specified physical good that represents a customizable game element.

To facilitate a better understanding of the present disclosure, it is helpful to know the following definitions used in the abstract, specifications, drawings, and claims:

computer: An electronic device capable of receiving input and performing computations;

videogame: A game played on a computer;

game: A game played on a computer;

game element: A thing existing within a game and having properties analogous to those of an object;

partially assembled: needing assembly;

purchase: To transact using real-world currency;

purchase order: A request for a good in exchange for real-world currency;

buy: To transact using in-game currency;

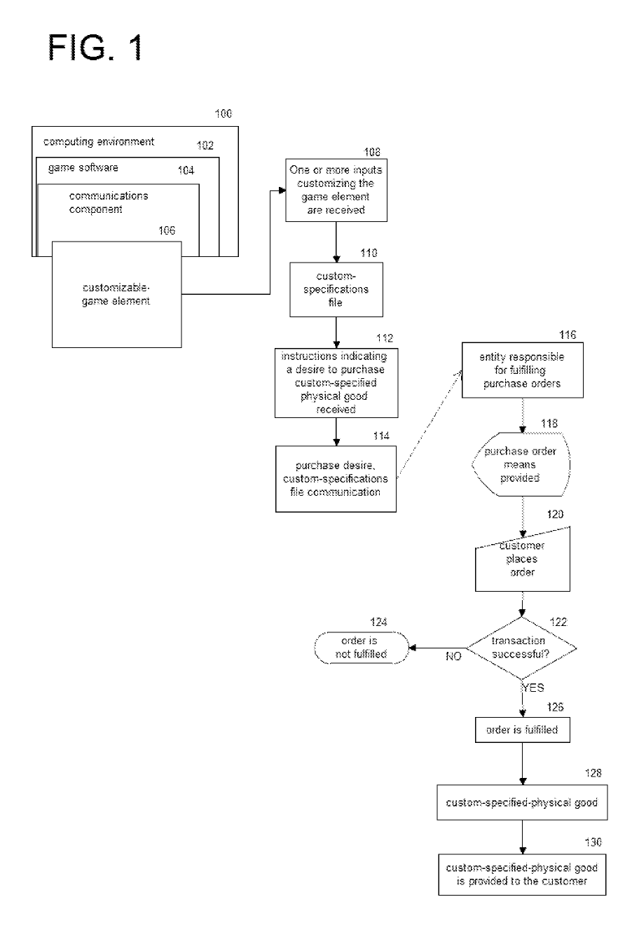

FIG. 1 illustrates the components of an embodiment in relation to one another.

Within a computing environment 100 software 102 in which users engage in conflict that is defined by rules and produces quantifiable results comprising a game, is provided. Thusly the playing of a game on a computer is enabled. Software 102 provides a communications component 104 for the communication of files to and from other networked systems. Software 102 allows for input instructing the customization of a game element 106. The customizable game element is ultimately a representation of a physical good, as such the game comprises a representation of a physical good.

One or more inputs from the user to develop the representation of the physical good are received by the computer 108. As a result of input instructing the customization of game element 106 software 102 produces a file 110 that comprises detailed descriptions of customizable game element 106. By extension, custom-specifications file 110 comprises detailed specifications from which a custom-specified physical good 126 can be elicited.

The software receives Instruction indicating a desire to purchase the custom-specified physical good 112. As a result, custom-specifications file 110 and a desire to purchase custom-specified physical good 112 are both communicated 114 to an entity responsible for fulfilling purchase orders 116.

Entity 116 provides a customer with an interface with which to place a purchase order 118. The customer places the purchase order 120. Entity 116 verifies the success of a purchase-order transaction 122. Embodiments in which the entity 116 is responsible for relaying data regarding the outcome of the transaction to software 102 are possible.

If purchase-order transaction 122 is not successful, the purchase order is not fulfilled 124. If purchase-order transaction 122 is successful, the purchase order is fulfilled 126 resulting in custom-specified physical good 128 being provided to the customer 130. Thusly it can be seen that the computerized method has enabled the purchasing of a physical good.

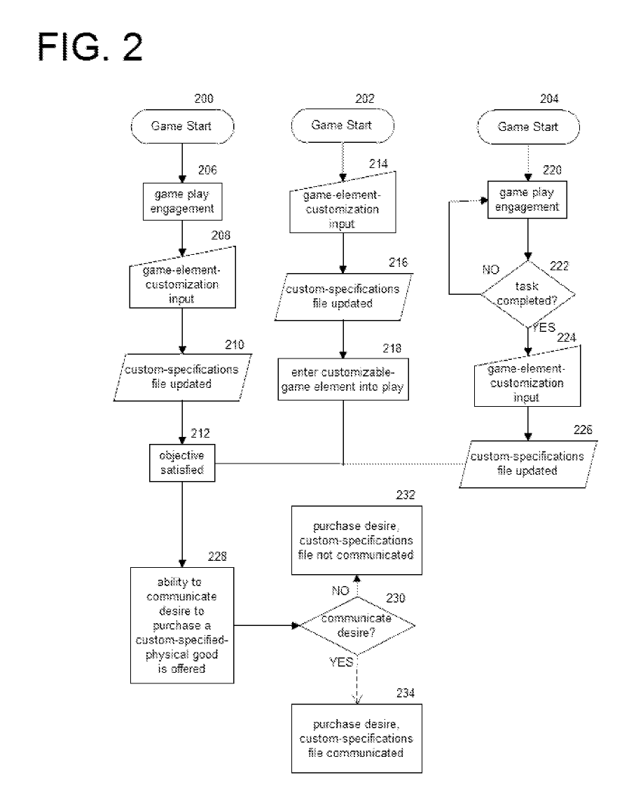

FIG. 2, demonstrates typical but not exhaustive implementations of the game component in terms of objectives, cause-and-effect relationships, hierarchies, and chronologies.

One embodiment of the game component 200, 206-212, 228, 230 may allow the customization of the game element to develop in the course of play. User inputs contribute to create a fully-developed representation of said physical good.

In another embodiment of the game component 202, 214-218, 228, 230 the customization of the game element may be a prerequisite of play. The computer receives a fully-developed representation of a physical good from the user before enabling the user to play the game.

A different embodiment of the game component 204, 220-226, 228, 230 may reward the user with the ability to customize the game element. The game comprises a fully-developed representation of the physical good before enabling the user to play the game and the computer is operatively arranged to receive an instruction from said user to purchase said physical good during game play. Additional embodiments in which the game component allows for the customization of the game element to be modified with random data are possible as are games in which the game element is inadvertently customized.

In the first embodiment of a game component 200, 206-212, 228-234 the customization of a game element develops in the course of play.

A game initializes 200 and a user engages in game-play 206. During game-play the user is able to customize the game element. This may be accomplished by allowing the user to customize a mansion-game element where the availability of game element customization items depends on successfully managing a city's resources.

The software receives one or more inputs 208 from the user to develop the representation of the physical good. The input updates a file 210 that is both a detailed description of the game element's customization and consequently, detailed specifications used to elicit a custom-specified physical good.

Having satisfied an objective 212 of customizing the game element, the user is allowed to communicate the custom-specifications file along with a desire to purchase the custom-specified physical good 228.

In this embodiment, the custom-specified physical good is a box set comprising assembly instructions and colorful-miniature-interlocking-plastic bricks that correspond in type, color, and quantity to those custom specified by the user in custom-specifications file 210. The custom-specified physical good arrives partially assembled.

In another embodiment of the game component 202, 214-218, 212, 228-234, the customization of a game element takes place at the outset of software initialization 202.

A user is required to customize the game element. This may be accomplished by requiring the user to customize a race-car-game element. The software receives input 214 instructing the customization of the game element. The input updates a file 216 that is both a detailed description of the customization of the game element and serves as detailed specifications used to elicit a custom-specified physical good.

The customizable game element can then be entered into play 218 and raced.

Having satisfied an objective 212 of customizing the game element, the user is allowed to communicate the custom-specifications file along with a desire to purchase a custom-specified physical good 228. The custom-specified physical good represents the customizable game element.

In this embodiment, the custom-specified physical good is a a remote-controlled racecar made according to the specifications in the custom-specifications file. In this embodiment, the purchase price of the custom-specified physical good is subsidized by the price of the game. Embodiments in which the purchase price of the custom-specified physical good is not subsidized are possible.

In the third embodiment of the game component 204, 220-234, the ability to customize a game element is offered to a user as a reward for game play.

A game initializes 204 and a user engages in game-play 220 and is given a task. In this embodiment the task is to successfully answer fashion related questions correctly.

The software assesses if the task has been completed 222. If the task has not been completed the software allows the user to re-engage in game play. If the task is completed the software allows the user to customize the game element.

The software receives input 224 instructing the customization of the game element. In this embodiment the game element is a fashion model which can be customized through the assignment of a plurality of garments in custom colors, designs, and combinations. The input updates a file 226 that is both a detailed description of the customizable game element and detailed specifications used to elicit a custom-specified physical good.

Having satisfied an objective 212 of customizing the game element, the user is allowed to communicate the desire to purchase the custom-specified physical good 228.

In this embodiment, the custom-specified physical good is a doll outfitted in the manner prescribed by the custom-specifications file. It is possible that the entity responsible for fulfilling purchase orders of the custom-specified physical goods will have goods preconfigured in such a way as to satisfy specifications prior to receiving custom-specification files. Embodiments in which the videogame enables the entity to crowd-source its product design are anticipated. In such a scenario, the custom-specified-physical good would be made publicly available for purchase as well.

In each embodiment, once the objective of customizing the game element has been satisfied 212, the software allows the player to re-engage in game play and game element customization.

The software allows for receipt of instruction indicating the user's desire to purchase the custom-specified physical good 230. If the software does not receive instruction indicating a desire to purchase the custom-specified physical good, no file and no desire is communicated 232. If at 230 the software receives instruction indicating a desire to purchase the custom-specified physical good, the desire to purchase the custom-specified physical good, along with the custom-specifications file, is communicated to the entity responsible for fulfilling the purchase order 234.

The entity responsible for fulfilling the purchase order is there-after responsible for facilitating the placing of the purchase order and its fulfillment.

In each embodiment of the game component, the software allows that the user be able to re-engage in game-play and game element customization. In each embodiment of the game component, the software allows that the user repeatedly communicate both the custom-specifications file and purchase desire 230 to the aforementioned entity.

Thus it is seen that the objects of the embodiments of the present disclosure are efficiently obtained in each embodiment though there are variations in the implementation of the game component.

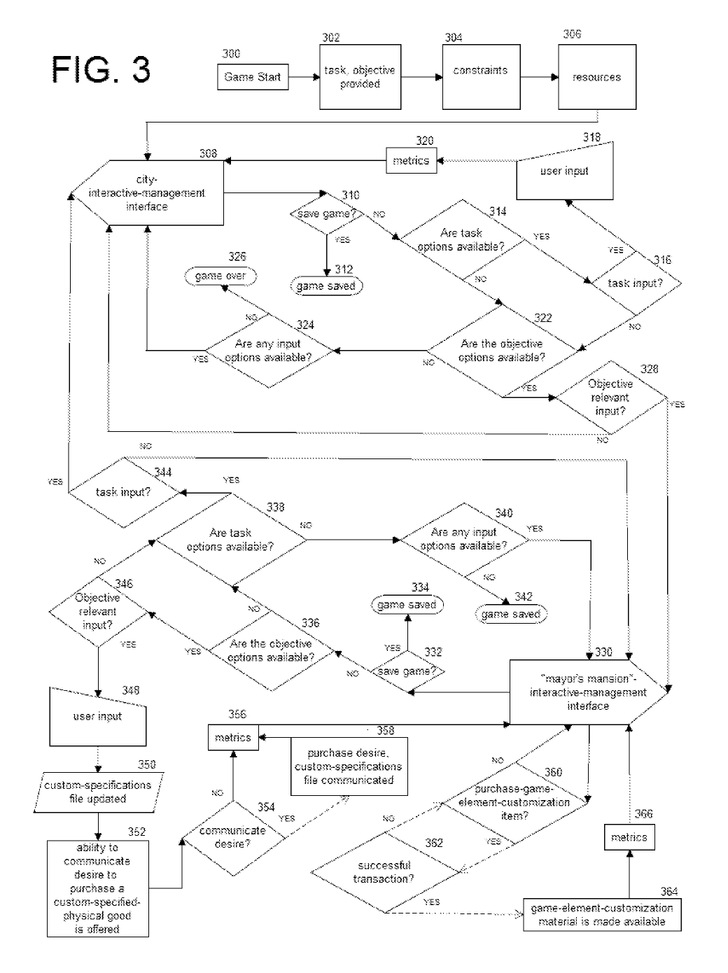

### Detailed Description—First Embodiment—FIGS. 3-4C, FIG. 7

FIG. 3 demonstrates an embodiment of the present disclosure. In an effort to provide a concise description of the embodiment, the description is not exhaustive nor does it put forth all the features of an actual implementation. It should be appreciated that when developing an actual implementation numerous implementation-specific decisions must be made and those decisions may vary from one implementation to the next, including but not limited to decisions relating to the implementation of the game component. Moreover, it should be appreciated that however complex and time consuming such a development effort might be, it would be a routine undertaking for those of ordinary skill having the benefit of this disclosure. In order to best enable this embodiment, the following flowchart describes the embodiment in terms of objectives, resources and constraints, input options, input received, and resultant cause-and-effect relationships. Input options have been ordered chronologically and grouped according to corresponding interactive-management interfaces.

FIG. 3 is a detailed flowchart describing, among other components, a game component similar to the game component referenced in part in FIG. 2; 200, 206-212, 228, 230. The game component is entitled “BrickTown.”

A game facilitated by software is initialized and begins 300.

The software provides a user with a task and an objective 302. By way of example but not limitation, the task (facilitated by a city-interactive-management interface) is to increase a city's population while managing its resources and the objective (facilitated by a “mayor's mansion”-interactive-management interface) is to customizes a “mayor's mansion”-game element. This is accomplished through the use of game element customization items corresponding to colorful-miniature-plastic bricks. Customizing the game element will update a file. From the custom-specifications file a custom-specified physical good can be elicited and made available for purchase.

The software provides the user with constraints 304. These constraints include a finite playing field, resource zone cost, and game element customization item cost. Embodiments involving other constraints, such as a time constraint, are possible.

The software provides the user with resources 306. Resources include an initial population value, different resource zone types (for constructing the city and enabling population growth), different game element customization items (for customizing a “mayor's mansion”), an initial revenue (the in-game currency used to buy different resource zone types), and an initial salary (the in-game currency used to buy game element customization items). Revenue is calculated according to a predetermined formula a function of which is population. Salary is calculated according to a predetermined formula, a function of which is revenue. The initial resources allocated the user must be sufficient to allow for success. Embodiments involving other resources enabling further game dynamics, such as infrastructure zone types, are possible.

The software provides the user with the city-interactive-management interface 308. Interface 308 displays available revenue, the current population, the types of zones available and their respective costs, a tool for enabling selection, a playing field, a tool with which to navigate the playing field, a tool for saving the game, and a selectable-“mayor's mansion”-interactive-management-interface icon.

At any time the software allows for input that would result in a saved game 310. Embodiments that do not allow for the game to be saved because the game-world is hosted online and is persistent, are possible.

If AT 310 the software receives instruction to save the game, the game is saved and a saved-game file is archived 312.

If at 310 the software doesn't receive instruction to save the game, the software determines if there are currently allowances for user input pertaining to the task 314. The software may allow user input if current revenue is sufficient to buy a resource zone.

If at 314 task input possibility is confirmed, the software allows for input relating to the task 316.

The software receives input pertaining to the task 318. Input pertaining to the task may involve receipt of instructions indication selection of a resource zone.

The software calculates the degree of success of the user's input and rewards the user accordingly 320. Success is a function of the number of different zones in play, the type of zones in play, the ratio of zones in play, and the proximity of zones to playing field features. Reward takes the form of an increase in population values, revenue values, and salary values. After calculating the degree of success of the user's input and rewarding the user accordingly, the software continues to provide interface 308.

If at 314 there are not allowances for user input pertaining to the task the software determines if there are currently allowances for user input pertaining to the objective 322. The software may allow for user input pertaining to the objective if the current salary is sufficient to buy a game element customization item or if a game element customization item is available for use as the result of a pertinent purchase.

If at 316 the software does not receive input pertaining to the task, the software determines if there are currently allowances for user input pertaining to the objective 322.

If at 322 there are not allowances for user input pertaining to the objective the software reassesses if there are currently allowances for any play related input 324.

If at 324 there are not allowances for user input pertaining to play, because current salary does not exceed and is not equal to the cost of a game element customization item and a game element customization item is not currently available for use as the result of a pertinent purchase and the current revenue does not exceed and is not equal to a resource zone, the software terminates 326.

If at 324, there are allowances for user input pertaining to play as a result of reassessment, the software continues to provide the user with interface 308.

If at 322 objective input possibility is confirmed, the software allows for input relating to the objective 328.

If at 328 the software does not receive input pertaining to the objective, the software continues to provide the user with interface 308.

If at 328 the software receives input pertaining to the objective, the software provides the “mayor's mansion”-interactive-management interface 330. Input pertaining to the objective is the receipt of instructions indicating the selection of interface 330 through the use of the selectable-“mayor's mansion”-interactive-management-interface icon.

The software provides the user with interface 330. Interface 330 facilitates the display of the current available salary, current revenue, game element customization items and their respective costs, tools with which to select, customize, orient, and position the game element customization items, a selectable-city-interactive-management-interface icon, a tool with which to save the game's progress, a selectable icon with which to indicate the desire to purchase the custom-specified physical good, a selectable icon with which to indicate the desire to purchase game element customization items, and a playing field. The game element customization items correspond to colorful-miniature-interlocking-plastic bricks. Embodiments involving game element customization items that correspond to other materials such as clay bricks and wood are possible.

At any time the software allows for input that would result in a saved game 332.

If at 332 the software receives instruction to save the game, the game is saved and a saved-game file is archived 334.

If at 332 the software does not receive instruction to save the game, the software determines if there are currently allowances for user input pertaining to the objective 336. Embodiments that allow for user input after receiving an automated instruction to remove a time constraint as the result of a pertinent purchase are possible.

If at 336 there are not allowances for user input pertaining to the objective the software determines if there are currently allowances for user input pertaining to the task 338.

If at 338 there are not allowances for user input pertaining to the task the software reassesses if there are currently allowances for user input pertaining to game play 340.

If at 340 there are not allowances for user input pertaining to game play, the software terminates 344.

If at 342 there are allowances for user input resulting from reassessment, the software continues to provide the user with interface 330.

If at 338 task input possibility is confirmed, the software allows for input relating to the task 344.

If at 344 the software does not receive input pertaining to the task, the software continues to provide the user with interface 330.

If at 344 the software receives input pertaining to the task, the software provides interface 308. Input pertaining to the task is the receipt of instructions indicating the selection of interface 308 through the use of the selectable-city-interactive-management-interface icon.

If at 336 objective input possibility is confirmed, the software allows input pertaining to the objective 346. Embodiments involving other determiners for the allowance of user input such as receiving an automated instruction to add a predetermined value to the user's salary as the result of a validated purchase order, are possible.

If at 346 the software does not receive input pertaining to the objective, the software determines if there are currently allowances for user input pertaining to the task 338.

If at 346 input pertaining to the objective is received, the game element is customized accordingly 348. The aforementioned input comprises the selection of game element customization items, and assignment of the game element customization items' colors, orientations, placement coordinates, and sequences.

The software updates a file resulting from the user input received 350. The custom-specifications file becomes a detailed description of the customizable game element and the customization process it underwent. The custom-specification file serves as detailed specifications used to elicit a custom-specified physical good and its assembly instructions. Upon further user input relating to the objective, the software updates the custom-specifications file.

The software also updates the custom-specifications file with a time signature whenever input indicating the desire to purchase the custom-specified physical good is received. It then saves a detailed description of the game element as it existed at that time in the custom-specifications file. Upon further receipt of input indicating the desire to purchase the custom-specified physical good, the software calculates the difference between the state of the game element associated with the most recent time signature and the current state of the game element. This is done with intent to elicit a custom-specified physical good comprising the difference between instances of the game element.

The computer is operatively arranged to receive an instruction from the user where the instruction indicates a desire to purchase the physical good during game play. The ability to communicate the desire to purchase the custom-specified physical good that corresponds to the customizable game element is possible 352.

The software allows for receipt of instruction indicating the user's desire to purchase the custom-specified physical good 354. Embodiments in which the instruction indicating a desire to purchase the physical good (whose representation is the customizable game element) is assessed remotely by additional software are possible.

If the software does not receive instruction indicating a desire to purchase a physical good whose representation is the customizable game element within a predetermined amount of time, the software calculates the success of the user's previous input 356. Success is calculated as a function involving the cumulative cost of the game element customization items.

If at 354 the software receives instruction indicating a desire to purchase the custom-specified physical good, the desire to purchase the custom-specified physical good is communicated to the entity responsible for fulfilling the pertinent purchase order 358. The custom-specifications file that serves as the specifications from which a custom-specified physical good can be elicited is likewise communicated 358. The entity responsible for fulfilling the custom-specified physical good purchase order is responsible for providing the user with a pertinent purchase order interface.

Afterward the software calculates the the success of the user's previous input 356.

Then the software continues to provide interface 330.

At any time that the software provides interface 330, the option to communicate a desire to purchase a game element customization item is made available to the user 360.

If at 360 the software does not receive instructions indicating the desire to purchase a game element customization item, the software continues to provide interface 330.

If at 360 the software receives instructions indicating the desire to purchase a game element customization item, that desire is communicated to an entity responsible for fulfilling a game element customization item purchase order. In this embodiment the entity responsible for fulfilling the game element customization item purchase order is also responsible for providing the user an interface with which to place the pertinent purchase order. Embodiments in which the purchase order interface is integrated into the game software's interfaces are possible.

The entity responsible for fulfilling the game element customization item purchase order is also responsible for verifying the success of the transaction 362 and communicating the result of the transaction back to the software.

If the software receives indication that the transaction has failed, the software continues to provide the user with the option of purchasing game element customization items 360.

If the software receives indication that the transaction was successful, the software allows the user the use of the purchased game element customization item 364.

If the transaction was successful, the software also receives and records data indicating the amount spent on the game element customization item purchase and later passes that information onto the entity responsible for fulfilling the purchase order of the custom-specified physical good. The information is passed on as part of the custom-specifications file. In this embodiment the entity responsible for fulfilling the custom-specified physical good is contractually obligated to discount the custom-specified physical good the amount spent purchasing game element customization items 366. Embodiments in which the cost of the custom-specified physical good isn't discounted are possible.

After calculating the discount to be applied to the custom-specified physical good, the software continues to provide interface 330.

It should be appreciated that this embodiment implements the game component as a simulation game. However, the present invention as claimed can obviously take the form of other embodiments implementing various videogame genres. For example, it is envisioned that embodiments will feature implementations of shooting games, fighting games, simulation games, action and adventure games, strategy games, and game genre hybrids.

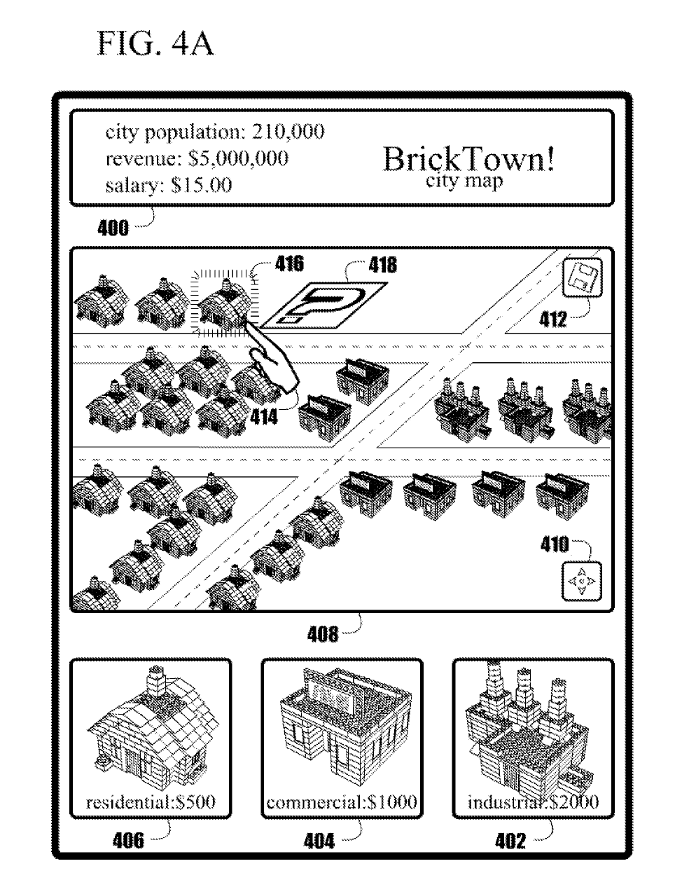

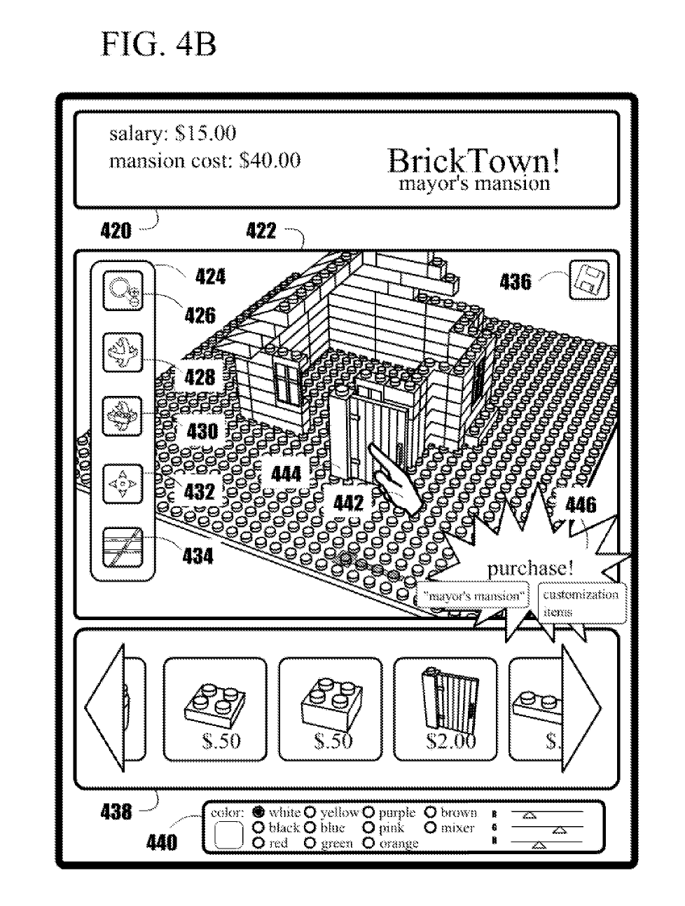

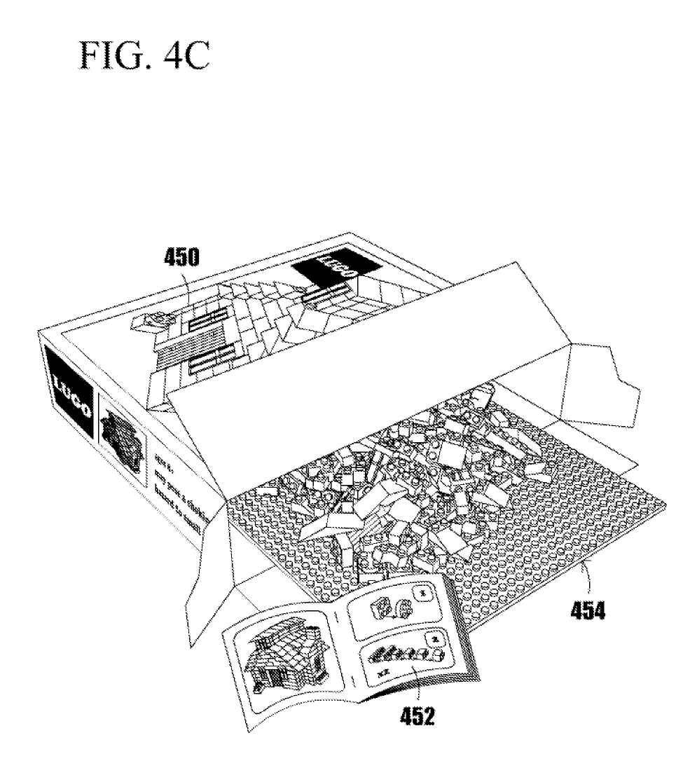

FIG. 4A is a screen-shot of the city-interactive-management interface in the game “BrickTown.”

The software displays important metrics relating to game-play; values for the city population (city population: 210,000), revenue (revenue: $5,000,000), and salary (salary: $15.00) 400.

At the bottom of the interface the software provides icons representing instances of resource zones; industrial 402, commercial 404, and residential 406 zones. Their respective costs in terms of revenue are provided as well; $2000 402, $1000 404, and $500 406. Multiple instances of resource zones can issue from their respective icons.

A playing field 408 on which to allocate the resource zones is provided.

The software provides a tool 410 for panning the field of view of the playing field area along x, y, and z axis.

412 is a selectable icon providing game saving functionality.

Using a selection tool 414, the software has received instructions from the user to select from the residential zone icon 406 an instance of a residential zone 416 and instructions to “drag and drop” the residential zone instance onto playing field 408.

The software will then calculate the ramifications of the user's input. The city revenue provided for in display 400 (revenue: $5,000,000) will be deducted the price of the residential zone (residential: $500).

Residential zone 416 being in play at the location specified will result in the addition of predetermined values at a predetermined rate to the current population total provided in display 400 (city population: 210,000).

Residential zone 416 being in play on the playing field will also achieve the predetermined optimal ratio of zoning resources; 3 residential zones for every 2 commercial zones for every 1 industrial zone. Achieving the optimal ratio will result in the addition of a predetermined value to the population total provided in display 400 (city population: 210,000).

The relative proximity of residential zone 416 to the commercial zones will also result in the addition of a predetermined value to the population total provided in display 400.

The cumulative effect of residential zone 416 being in play on the playing field is that the city population provided in display 400 (city population: 210,000) will increase through the addition of several predetermined values. Conversely, ill-conceived placement of resource zones would result in a failure to effectively increase the city population total.

The revenue value provided in display 400 (revenue: $5,000,000) will ultimately increase as it is calculated as a function dependent upon the population value. Sustained ill-conceived placement of resource zones combined with over-spending would eventually result in revenue that would not be sufficient to buy a resource zone.

The salary value provided in display 400 (salary: $15.00) will also increase as it is calculated as a function dependent upon the revenue value.

Once the salary value provided in display 400 is sufficient to buy a game element customization item, the software allows for the selection of the playing field area designated with a square and question mark 418.

Designation 418 represents the location of the “mayor's mansion”.

Once the software receives input indicating the selection of designation 418, the software presents the “mayor's mansion”-interactive-management interface FIG. 4B.

FIG. 4B is a screen-shot of “BrickTown's” the “mayor's mansion” interactive management interface. Display 420 comprising important metrics relating to values for salary (salary: $15.00) and the cumulative cost of a “mayor's mansion” (mansion cost: $40.00) is provided. The “mayor's mansion” is a customizable game element.

An area 422 in which to customize the game element is provided and defined in terms of Euclidean-coordinate geometry.

Tools for customizing the game element are provided and arranged on a tool bar 424.

The software provides a tool 426 for increasing and decreasing the field of view with respect to area 422.

428 is a tool facilitating the rotation of the field of view along x, y, and z axis with respect to area 422.

A tool 430 used to orient game element customization items along x, y, and z axis is provided.

432 can be used to pan the field of view of area 422 along x and y axis.

The software provides a selectable-city-interactive-management-interface icon 434 facilitating the return to the city-interactive-management interface.

Development of the customizable game element can be saved through interaction with the game save icon 436.

The software provides a menu with icons representing instances of game element customization items and their respective costs 438. Multiple instances of game-element customization items can issue from their representative icons.

Menu 438 also utilizes direction indicating triangles which facilitate scrolling the menu left and right so as to efficiently allow the selection of game element customization items. This is because providing all game element customization items to the user simultaneously is not the most efficient use of space within menu 438.

Below menu 438 the software provides interface 440 for assigning selected game-element customization items a choice of color.

Interface 440 also allows for custom color creation through the “mixer” option. Selection of the mixer option allows for input of RGB values through the use of slider bars.

Tool 442 is used for interacting with the interface. Tool 442 can be used for selection and manipulation.

The software has received instruction indicating the selection of a game element customization item, a “door” 444 from menu 438 and has received further input indicating the “door's” orientation and location within area 422.

When the game element customization item is placed, the cost ($2.00) of the game element customization item specified in menu 438 will be deducted from the salary value (salary: $15.00) specified in display 420. This is only accomplished if the game element customization item was bought.

Further, once the game element customization item is placed, the cost of the game element customization-material specified in menu 438 will be added to the “mansion cost” value (mansion cost: $40.00) specified in display 420. This is only accomplished if the game element customization item was bought. Game element-customization-materials can be removed by selecting a building material and “drag and dropping” it outside of area 422.

The software has generated a visual of all pertinent input and provided the visual of the customizable game element within area 422.

At this point input pertaining to the objective has been received and the customizable game element has been customized accordingly. This input has instructed the selection of game element customization items, and assigned the game element customization items colors, orientations, placement coordinates, and sequence. The software updates a file resulting from the user input received. The custom-specifications file is a detailed description of the customizable game element and the customization process it underwent. The custom-specification file therefore can serve as detailed specifications used to elicit a custom-specified physical good and its assembly instructions. The customizable game element is a representation of the custom-specified physical good.

Icon 446 allows the user to choose to communicate the desire to purchase game element customization items. Icon 446 also allows the user to choose to communicate the desire to purchase the custom-specified physical good. Purchase desire is communicated to the entity responsible for fulfilling the purchase order. Along with the desire to purchase the custom-specified physical good, the custom-specifications file is also communicated to the entity responsible for fulfilling the custom-specified physical good purchase order. The entity responsible for fulfilling the custom-specified physical good purchase order is responsible for providing the user an interface with which to place the pertinent order.

FIG. 4C Displays the custom-specified physical good in partially assembled form.

The artwork on the box utilizes a rendering of the customizable game element 450 as customized by the user.

Among the plurality of parts are assembly instructions. An assembly instruction booklet 452 has been created utilizing renders and information derived from user input specifying the type, color, and quantity of miniature-interlocking-plastic bricks and items and their orientation, placement coordinates, and sequence.

The custom-specified physical good 454 whose representation is the customizable game element contains the type, color, and quantity of miniature-interlocking-plastic bricks and items specified in the custom-specifications file updated as a result of the user's input. The custom-specified physical good comprises a plurality of parts. The custom-specified physical good arrives partially assembled.

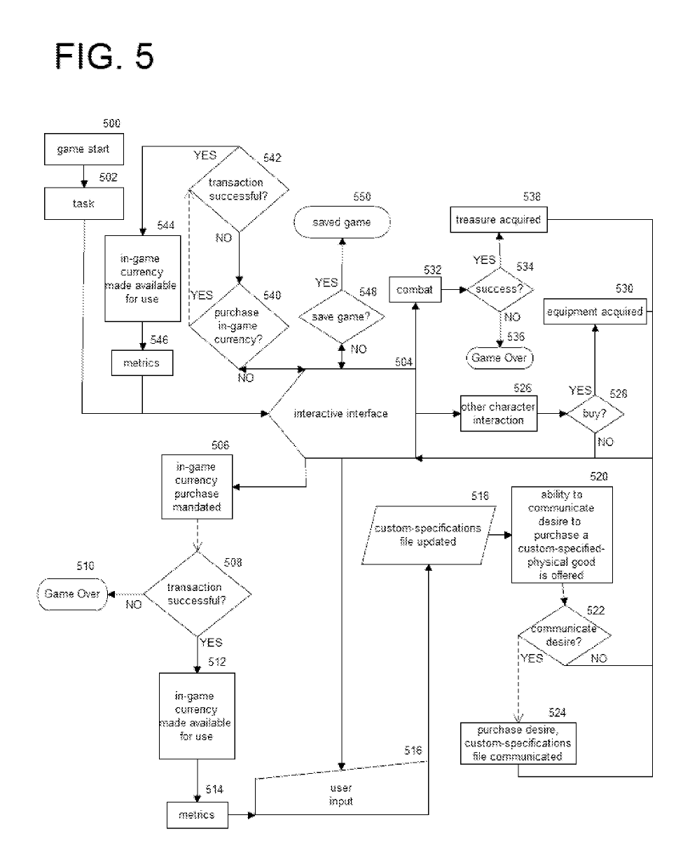

FIG. 5 demonstrates an embodiment of the present disclosure. In an effort to provide a concise description of the embodiment, the description is not exhaustive nor does it put forth all the features of an actual implementation. It should be appreciated that when developing an actual implementation numerous implementation-specific decisions must be made and those decisions may vary from one implementation to the next, including but not limited to decisions relating to the embodiment of the game component and dependent variations. Moreover, it should be appreciated that however complex and time consuming such a development effort might be, it would be a routine undertaking for those of ordinary skill having the benefit of this disclosure. In order to best enable this embodiment, the following flowchart describes the software in a manner consistent with the open-ended nature of the role playing genre and in terms of character encounters, input options, input received, and resultant cause-and-effect relationships.

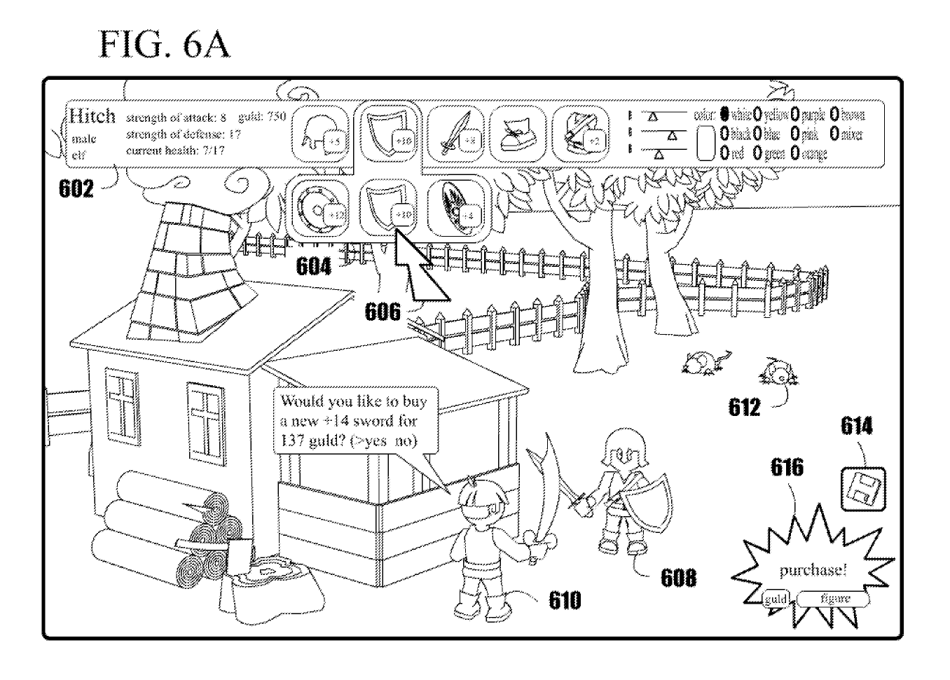

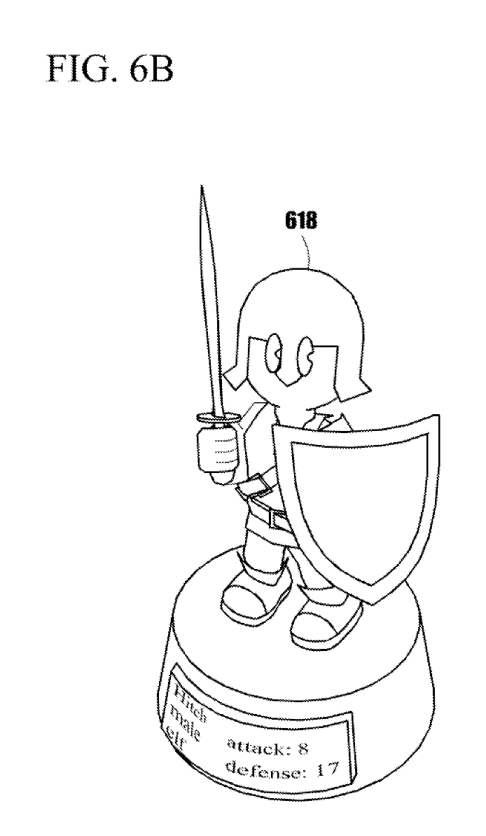

### Detailed Description—Second Embodiment—FIGS. 5-6B

FIG. 5 is a flowchart enabling the development of an embodiment of the present disclosure.

A game is initialized and begins 500.

A user is provided with a task 502. This task is for the user to defeat enemies using a playable character. The playable character is a customizable game element. As the game progresses, the enemies encountered will become increasingly difficult to defeat so as to necessitate the customizable game element be customized through equipment upgrades. The equipment, such as swords, shields, and clothing, are the game element customization items. The objective is to customize the customizable game element resulting in a custom-specifications file from which a custom-specified physical good be elicited and made available for purchase.

The software's interface 504 provides game element customization items, important metrics relating to game play, a game play environment, characters assigned as hostile, characters assigned as friendly, a selectable icon with which to save the game's progress, a selectable icon with which to communicate the desire to purchase amounts of the in-game currency of “guld,” tools with which to customize the game element, a selectable icon with which to communicate the desire to purchase a custom-specified physical good, and the playable character that is the customizable game element.

The software allows that the user may at any time purchase an amount of guld. The software does mandate, however, that the user must purchase an amount of guld at the outset of the game 506.

The entity responsible for fulfilling the guld-purchase order is also responsible for providing the user with an interface facilitating the guld-purchase order, verifying the success of the transaction 508 and communicating the result of the transaction back to the software.

If the software receives data indicating that the transaction has failed the game terminates 510.

If at 508 the software receives data indicating a successful transaction, the software updates the user's guld totals and allows the user the use of the guld purchased to buy game element customization items 512.

If the transaction was successful, the software also receives and records data indicating the amount spent on the guld purchase and later passes that information onto the entity responsible for fulfilling the purchase order of the custom-specified physical good. The information is passed on as part of the custom-specifications file. In this embodiment the entity is contractually obligated to discount the custom-specified physical good the amount spent purchasing guld 514. Embodiments in which the cost of the custom-specified physical good isn't discounted are possible.

The software allows that the user may at any time customize the customizable game element. The software does mandate, however, that the user must customize the game element at the outset of the game. The software receives input indicating game element customization 516. Customization of the game element involves specifying its name, the selection and assignment of gender, race, equipment, and the customization of equipment through the selection and assignment of colors.

The software updates a file resulting from the user input received 518. The custom-specifications file thus becomes a detailed description of the customizable game element. The custom-specifications file serves as detailed specifications used to elicit a custom-specified physical good.

The ability to communicate the desire to purchase the custom-specified physical good whose representation is a customizable game element is now possible 520.

The software allows for receipt of instruction indicating the user's desire to purchase the custom-specified physical good 522. Embodiments in which the instruction indicating a desire to purchase the physical good whose representation is the customizable game element is assessed remotely by additional software are possible.

If the software receives instruction indicating a desire to purchase the custom-specified physical good, the desire to purchase the custom-specified physical good is communicated to the entity responsible for fulfilling the custom-specified physical good purchase order 524. The custom-specifications file that serves as the specifications from which a custom-specified physical good can be elicited is likewise communicated 524. The entity responsible for fulfilling the custom-specified-physical -good-purchase order is responsible for providing the user an interface with which to place the pertinent purchase order.

If at 522 input indicating a desire to purchase the custom-specified physical good is not received, the software continues to provide the interactive interface 504.

If a determination by the software concludes that the predetermined proximity of the customizable game element and the friendly character coincide, character interaction results 526. Character interaction takes the form of buying equipment with “guld”.

Input indicating a desire to confirm a transaction with the friendly character is allowed 528.

If at 528 the software receives input indicating the desire to complete the transaction, the transaction is facilitated 530. The user buys the equipment. The game element acquires the equipment and the equipment is placed in its inventory. The amount that the equipment was bought for is deducted from the “guld” total. The software continues to provide the interactive interface 504.

If at 528 the software does not receive input confirming the transaction, the software continues to provide interactive interface 504.

If the software determines that the predetermined proximities of the customizable game element and an enemy coincide, combat results 532. Combat takes the form of the enemy trying to execute an attack that intercepts the coordinates of the customizable game element and trying to avoid the customizable game element when the attack has lapsed while the customizable game element attempts to do the same with regards to the enemy.

The software calculates the success of the user's input 534. Success may be defined as occurring when the customizable game element has executed an attack that intercepts the enemy's coordinates a predetermined number of times while avoiding having the customizable game element's coordinates intercepted by an attack a predetermined number of times.

If the software determines that an enemy's attack has intercepted the playable customizable character's coordinates and that the intercepting attack has served to exceed the predetermined number of intercepting attacks the customizable game element is allowed to receive, game play is terminated 536. The number of intercepting attacks the customizable game element is allowed to receive is a function of the total defensive strength of the equipment the customizable game element is currently assigned.

If at 536 the software determines that the character is successful, treasure is acquired 538. The reward consists of an amount of “guld” and a piece of equipment. The software continues to provide the interactive interface 504.

At any time that the software provides interface 504, the option to purchase guld is made available to the user 540.

If the software does not receive instructions indicating the desire to purchase guld, the software continues to provide interface 504.

If at 540 the software receives instructions indicating the desire to purchase guld, that desire is communicated to an entity responsible for fulfilling the guld-purchase order. In this embodiment the entity responsible for fulfilling the guld-purchase order is also responsible for providing the user an interface with which to place the purchase order. Embodiments in which the guld-purchase order interface is integrated into the software's existing interface are possible.

The entity responsible for fulfilling the guld-purchase order is also responsible for verifying the success of the transaction 542 and communicating the result of the transaction back to the software.

If at 542 the software receives indication that the transaction has failed, the software continues to provide the user with the option of purchasing guld 540.

If at 542 the software receives indication that the transaction was successful, the software allows the user the use of the purchased guld 544.

If the transaction was successful, the software also receives and records data indicating the amount spent on the guld purchase and later passes that information onto the entity responsible for fulfilling the purchase order of the custom-specified physical good. The information is passed on as part of the custom-specifications file. In this embodiment the entity is contractually obligated to discount the custom-specified physical good the amount spent purchasing guld 546. Embodiments in which the cost of the custom-specified physical good isn't discounted are possible.

After calculating the discount to be applied to the custom-specified physical good, the software continues to provide interface 504.

At any time the software allows for input that would result in a saved game 548.

If the software receives instruction to save the game, the game is saved and a saved game file is archived 550.

If at 548 the software doesn't receive instruction to save the game, the software continues to provide the interactive interface.

FIG. 6A is a screen-shot of an interface of the game “Super Super RPG” implemented by software that demonstrates an embodiment and use thereof. The embodiment was described in FIG. 5. In an effort to provide a concise description of the embodiment, the description is not exhaustive nor does it put forth all the features of an actual implementation. It should be appreciated that when developing an actual implementation numerous implementation-specific decisions must be made and those decisions may vary from one implementation to the next, including but not limited to decisions relating to the implementation of the game component and its dependent variations.

At the top of the screen-shot is interface 602.

Interface 602 allows input relating to a customizable game element's 608 customizable features.

The customizable features comprise name, gender, race, and game element customization items in the form of equipment. The game element customization items comprise head-wear, shields, weapons, footwear, and torso-wear. Interface 602 provides tools facilitating the assignment of custom colors to the game element customization items and also allows for custom-color creation through the “mixer” option. Selection of the mixer option allows for input of RGB values through the use of a slider bar interface.

Interface 602 displays important metrics relating to values of element's 608 strength of attack (8), strength of defense (17), current health (7/17), and “guld” (750). The amount of “guld” is a function of the cumulative amount of “guld” acquired as a result of successful combat and purchase less the amount of “guld” spent acquiring game element customization items. The strength of attack is a function of the attack value (+8) of the weapon (sword) game element customization item currently assigned to the customizable game element. The strength of defense value (17) is a function of the total of the defense values of the head-wear (helmet, +5), shield (+10), and torso-wear (tunic, +2) currently assigned. The current health value is a function of the strength of defense value (+17) less the number of attacks (10) that have successfully intercepted the customizable game element's coordinates. When the current health value equals 0, the software terminates game play. The assignment of a new defense-game element customization item to the customizable game element will add to the health numerator the amount of the difference between it and the defense-game element customization item being swapped out unless the difference is negative. The customizable game element is initialized in such a way as to make successful combat possible.

The software provides a tool for selecting game element customization items 606. After selecting the currently assigned shield from interface 602, the software provides a sub-menu 604 of shields to select from. The sub-menu displays inventory. Once a shield is selected from the sub-menu it is assigned to element 608 and displayed in interface 602. Once assigned and while still selected, the shield's color can be customized. The other game element customization items can be assigned and customized through the same process.

The software provides element 608. The software has generated a visual of customization input and provided that visual as element 608. Element 608 is a playable character. Element 608 can receive input indicating a direction in which to move and input resulting in the execution of an attack.

The software provides a friendly character 610 whose proximity coordinates correspond to the coordinates of element 608. Character interaction results. The interaction allows for input affirming a transaction. The transaction allows the user to buy a sword. Affirmation of the transaction would result in the deduction of 137 “guld” from the current “guld” total in exchange for the allowance of the selection of a new sword having a +12 attack value from the sword sub-menu of interface 602.

The software provides an enemy 612 whose proximity co-ordinates do not correspond to the coordinates of element 608, thereby currently disallowing combat.

The software provides a selectable icon with which to save the game's progress 614.

The software has received input indicating the name, gender, race, and type and color of game element customization items assigned to element 608 and has assessed the strength of attack and strength of defense of element 608. The user's input results in the customization of element 608. The software has the information it needs to update a file that is the custom specifications from which a corresponding physical good and can be elicited. The custom-specifications file is communicated to the entity responsible for fulfilling the purchase order of the custom-specified physical good.

Icon 616 allows the user to choose to communicate the desire to purchase “guld”. Icon 616 also allows the user to choose to communicate the desire to purchase the custom-specified physical good to the entity responsible for fulfilling the pertinent purchase order. Along with the desire to purchase, the custom-specifications file is also communicated to the entity responsible for fulfilling the pertinent purchase order. It is from this file that the custom-specified physical good can be elicited. The entity responsible for fulfilling the purchase order is responsible for providing the user an interface with which to place an order.

FIG. 6B By way of example but not limitation, displays a custom-specified physical good whose representation is the customizable game element 608. The physical good arrives fully-assembled being comprised of one part.

The physical good whose representation is the customizable game element 608 has taken the form of a figure 618 as specified in the custom-specifications file created as a result of game play.

The figure 618 is a custom-specified physical good representing customizable game element 608 and comprises aspects corresponding to game element customization items, such as a shield, specified in the custom-specifications file created as a result of game play.

Figure 618 displays the name, gender, race, and important metrics relating to values of element's 608 strength of attack and strength of defense as specified in the custom-specifications file created as a result of game play.

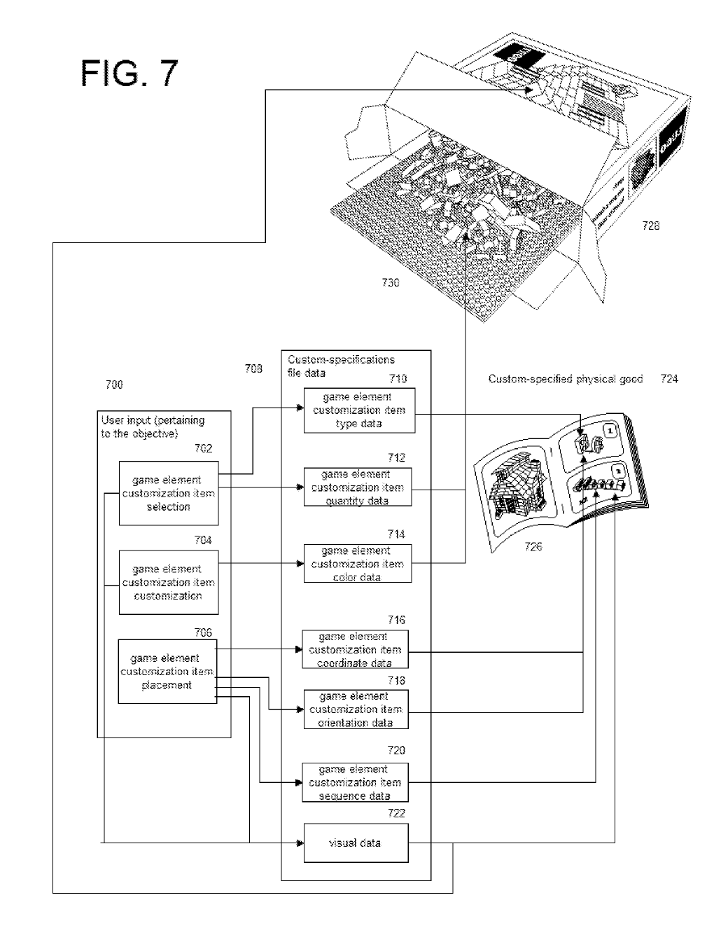

FIG. 7 illustrates the relationship between user input, the custom-specifications file, and the custom-specified physical good in an embodiment implementing the game component “BrickTown.” It should be appreciated that not all user input is shown here. It should be further appreciated that not all custom-specifications file data (such as time signatures or customizable game element save states) is shown here.

The software allows user input pertaining to the objective of customizing a game element 700.

Input 700 comprises game element customization item selection 702, game element customization item customization 704, and game element customization item placement 706.

Game element customization item type data 710 and game element customization item quantity data 712 are derived from selection 702. Game element customization item color data 714 is derived from customization 704. Game element customization item coordinate data 716, game element customization item orientation data 718, and game element customization item sequence data 720, are derived from placement 706. Visual data 722 is derived from selection 702, customization 704, and placement 706.

Custom-specified physical goods 724 are elicited from file data 708.

Assembly instructions 726 are elicited from visual data 722, type data 710, quantity data 712, color data 714, sequence data 720, orientation data 718, and coordinate data 716. Packaging 728 is elicited from visual data 722. The type, quantity, and color of colorful-miniature-interlocking-plastic bricks are elicited from type data 710, quantity data 712, and color data 714.

Thus it is seen that through game play, user input results in custom-specifications file data from which custom-specified physical goods can be elicited.

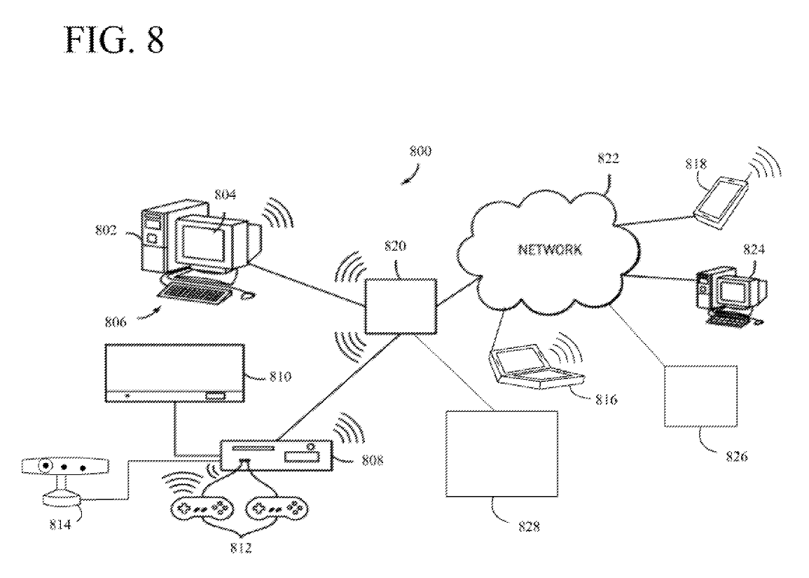

FIG. 8 depicts a system that may be used when playing a videogame and eliciting a custom-specified physical good in accordance with an embodiment of the present disclosure. In one embodiment, the system 800 may include one or more computers such as computer 802. Computers may integrally or separately include a display 804 and may be physically or wirelessly coupled to one or more input devices 806, e.g. a mouse and keyboard. The input devices may allow interaction with computer 802 and may enable a user to play videogames and generally interact with a user interface.

In some embodiments, the computer 808 may be of the game console variety and coupled to a display 810. Computer 808 may be physically or wirelessly coupled to one or more input devices 812, a “controller” that enables a user to control computer 808 and play videogames. The input device may be a “controller-free” input device 814 that utilizes sensory type data to control computer 808 and play videogames.

Computer 808 may be of the console variety such as a Microsoft Xbox™, Microsoft Xbox360™, Sony Playstation™, Sony Playstation 2™, Sony, Playstation 3™, Nintendo Gamecube™, Nintendo Wii™, or any suitable game console. In other embodiments, computer 808 may be or may include a digital video recorder (DVR), a DVD player, a CD player, a digital audio player, an audio receive, a video receiver, a cable converter box, a satellite receiver, a streaming media player, and/or any combination thereof. The display 804 coupled to computer 802 and the display 810 coupled to computer 808 may be any suitable display, such as a plasma display, LCD display, DLP display, CRT display, laser display, OLED display, laser display, etc.

Computer 816 is of the mobile gaming variety and computer 818 is of the mobile communications variety. Computers 802 and 808 may be physically or wirelessly coupled to a network 822 or network interface.

Computers 802, and 808 may be physically or wirelessly coupled to a networking interface 820 to enable communication to and from a network 822. In some embodiments, the networking interface 820 may be a cable modem, DSL modem, satellite modem, router, switch, hub, and/or any combination thereof. The network 822 may include a local-area-network (LAN), wide-area-network (WAN), campus-area network (CAN), municipal area network (MAN) and/or the Internet. Computer 808 may communicate with other computers 824 over network 822. For example, computers 824 coupled to the network 822 may include additional computers 818 of the mobile communications variety. In some embodiments, a videogame executed on computer 808 may enable users of computer 808 to interact with users of other computers (such as are computers 824, computers 818, and computer 816 over the network 822), by playing a videogame against or with other users. Additionally, the computer 808 may communicate with a computer 826 of the server variety that is coupled to the network 822. For example, the computer 808 may send and receive data to and from computer 826, such as software updates, videogame data, etc. In some embodiments, the server 830 may receive the custom-specifications file from computer 808.

In some embodiments, a materials printer 828 may receive the custom-specifications file from computer 808 and serve as the entity responsible for fulfilling the custom-specified physical good purchase order. Printer 828 may be physically or wirelessly coupled to network 822 or to a networking interface 820 to enable communication to and from network 822.

Thus it is seen that the objects of the embodiment may be efficiently obtained by network connectivity. A high-speed network environment best facilitates the communication of the desire to purchase a custom specified physical good and best facilitates the communication of the custom specifications file.

### Conclusion, Ramifications, and Scope

Thus it is seen that the objects of the preceding embodiments are efficiently obtained. While the embodiments have been disclosed in order to facilitate understanding of the invention set forth in the appended claims, it should be appreciated that embodiments may take various forms without departing from the principle or scope of the present invention set forth in the appended claims.

What I claim is:

1. A computerized method of enabling the purchasing of a physical good, comprising the steps of:
enabling the playing of a game on a computer by a user, said game comprising a representation of said physical good;
receiving one or more inputs from said user to develop said representation of said physical good; and,
receiving an instruction from said user where said instruction indicates a desire to purchase said physical good and said physical good is associated with said representation.

2. The computerized method recited in claim 1 wherein said game comprises a fully-developed representation of said physical good before enabling said user to play said game.

3. The computerized method recited in claim 1 wherein said computer receives a fully-developed representation of said physical good from said user before enabling said user to play said game.

4. The computerized method recited in claim 1 wherein said inputs contribute to create a fully-developed representation of said physical good.

5. The computerized method recited in claim 1 wherein said computer is operatively arranged to receive an instruction from said user where said instruction indicates said desire to purchase said physical good during game play.

6. The computerized method recited in claim 1 wherein said physical good comprises a plurality of parts.

7. The computerized method recited in claim 6 wherein said plurality of parts comprises one or more assembly instructions.

8. The computerized method recited in claim 1 wherein said physical good is fully-assembled.

9. The computerized method recited in claim 1 wherein said physical good is partially assembled.

10. The computerized method recited in claim 5 wherein said physical good comprises one or more parts.

11. The computerized method recited in claim 10 wherein said physical good comprises one or more assembly instructions.

12. The computerized method recited in claim 1 wherein the purchase cost of said physical good is subsidized by purchase costs associated with said game.

13. The computerized method recited in claim 12 wherein said purchase costs associated with said game are those of said game.

14. The computerized method recited in claim 12 wherein said purchase costs associated with said game are those of downloadable content.

15. The computerized method recited in claim 12 wherein said purchase costs associated with said game are those of unlockable content.

16. The computerized method recited in claim 12 wherein said purchase costs associated with said game are those of an in-game currency.

13. The computerized method recited in claim 1 wherein said physical good comprises the difference between two or more instances of said representation.

14. The computerized method recited in claim 1 wherein said physical good is produced by a materials printer.
